(19) United States
(12) Patent Application Publication
(10) Pub. No.: US 2009/0323641 A1
(43) Pub. Date: Dec. 31, 2009

(54) RADIO COMMUNICATION MOBILE STATION DEVICE AND MCS SELECTION METHOD

(75) Inventors: Sadaki Futagi, Ishikawa (JP); Daichi Imamura, Kanagawa (JP); Yoshihiko Ogawa, Kanagawa (JP); Atsushi Matsumoto, Ishikawa (JP); Takashi Iwai, Ishikawa (JP); Katsuhiko Hiramatsu, Leuver (BE)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATION, Osaka (JP)

(21) Appl. No.: 12/514,270

(22) PCT Filed: Nov. 9, 2007
(86) PCT No.: PCT/JP2007/071802

§ 371 Date: May 29, 2009

(30) Foreign Application Priority Data
Nov. 10, 2006 (JP) 2006-305354

(51) Int. Cl. H04B 7/216

(52) U.S. Cl. 370/335

(57) ABSTRACT

Provided is a radio communication mobile station device capable of preventing a transmission delay when a transmission data amount is increased in a radio communication system where persistent scheduling is performed. In this device, an MCS selection unit (104) selects a first MCS if the transmission data amount accumulated in a buffer of a data control unit (105) is smaller than a threshold value and selects a second MCS having a higher MCS level than the first MCS if the transmission data amount is not smaller than the threshold value. Thus, in a mobile station (100), data encoded and modulated according to the first MCS is transmitted during a normal state when the transmission data amount is small, and data encoded and modulated according to the second MCS having a higher MCS level than the first MCS is transmitted when the transmission data amount is increased to a large amount.

### TECHNICAL FIELD

The present invention relates to a radio communication mobile station apparatus and an MCS selection method.

### BACKGROUND ART

Presently, in 3GPP RAN LTE (Long Term Evolution), studies are underway to use persistent scheduling, in which transmission resources are assigned to given periods in which a plurality of subframes constituting one unit, in real-time packet transmission of constant-bit-rate small capacity such as VoIP (Voice over Internet Protocol) and Gaming (see Non-Patent Document 1).

In persistent scheduling, radio communication base station apparatus (hereinafter simply “base station”) determines the MCS (Modulation and Coding Scheme), and RA (Resource Assignment) including the resource block size and resource block positions, for a plurality of subframes, collectively, using the SINR (Signal to Interference and Noise Ratio) of a pilot signal from a radio communication mobile station apparatus (hereinafter simply “mobile station”), and reports them to the mobile station. That is, in persistent scheduling, the same MCS and RA are used over a plurality of sub frames. By this persistent scheduling, it is possible to reduce the rate of reporting MCS and the rate of reporting RA per mobile station and suppress the amount of control signals in an entire downlink. In particular, in VoIP, it is necessary to provide voice service to a large number of mobile stations at the same time, so that the effect of persistent scheduling is significant.

On the other hand, in packet transmission using the IP network, it is known that packet transmission jitters and packet transmission delay are generated in the routers. VoIP routers, for example, also perform processing for packets other than voice packets at the same time as processing for voice packets, and therefore, this processing at the same time causes transmission jitter and transmission delay to voice packets. For example, if a voice packet arrives at a router while the router is transferring another IP packet, the voice packet needs to wait in the router until this IP packet transfer is complete, and therefore transmission delay of the voice packet is generated in the router, as a result, transmission jitter of the voice packet is generated.

In the case where, due to packet transmission jitters and so on, the amount of transmission data momentarily increases in the middle of a plurality of subframes subjected to persistent scheduling, the mobile station requests the base station to transmit a resource request signal and requests increased resource assignment. Upon receiving the resource request signal from the mobile station, the base station secures the transmission resource in uplink and further assigns transmission resources to the mobile station (see Non-Patent Document 2).

Non-patent Document 1: 3GPP TSG-RAN WG1 LTE Ad Hoc Meeting, R1-060099, “Persistent Scheduling for E-UTRA,” Helsinki, Finland, 23-25 Jan., 2006

Non-patent Document 2: 3GPP TSG-RAN WG1 Meeting #44, R1-060536, LG Electronics, “Uplink resource request for uplink scheduling,” Denver, USA, 13-17 Feb., 2006

### DISCLOSURE OF INVENTION

### Problems to be Solved by the Invention

However, with the above conventional technique, when the amount of transmission data increases momentarily, extra data can be transmitted after the mobile station requests resources and the base station assigns transmission resources in response to the resource request, and therefore, transmission delay of the extra data is generated. For this reason, in communication services requiring real time performance including VoIP, QoS (Quality of Service) cannot be fulfilled.

It is therefore an object of the present invention to provide a mobile station and MCS selection method that can prevent transmission delay when the amount of transmission data increases in radio communication systems in which persistent scheduling is performed.

### Means for Solving the Problem

The mobile station of the present invention provides a mobile station for transmitting transmission data using a transmission resource assigned in a given period by persistent scheduling, and adopts a configuration including: a selection section that selects one of a first modulation and coding scheme and a second modulation and coding scheme, the second modulation and coding scheme having a higher modulation and coding scheme level than the modulation and coding scheme level of the first modulation and coding scheme, according to an amount of transmission data varying in the given period; and a coding and modulation section that encodes and modulates transmission data according to the selected modulation and coding scheme.

### ADVANTAGEOUS EFFECT OF THE INVENTION

According to the present invention, it is possible to prevent transmission delay when the amount of transmission data increases in radio communication systems in which persistent scheduling is performed.

### BRIEF DESCRIPTION OF DRAWINGS

FIG. 1A shows a relationship between received power and interference power in a pilot channel;

FIG. 1B shows a relationship between received power and interference power in a data channel;

FIG. 2 illustrates a sequence diagram of the operations according to Embodiment 1;

FIG. 3 is a block diagram showing the configuration of a mobile station according to Embodiment 1;

FIG. 4 is an MCS table according to Embodiment 1;

FIG. 5 illustrates a sequence diagram of the operations according to determination example 1 of Embodiment 2;

FIG. 6 illustrates a sequence diagram of the operations according to determination example 2 of Embodiment 2;

FIG. 7 is a block diagram showing the configuration of a mobile station according to Embodiment 3;

FIG. 8 shows a variation of transmission power according to Embodiment 3; and

FIG. 9 illustrates coordination between cells.

### BEST MODE FOR CARRYING OUT THE INVENTION

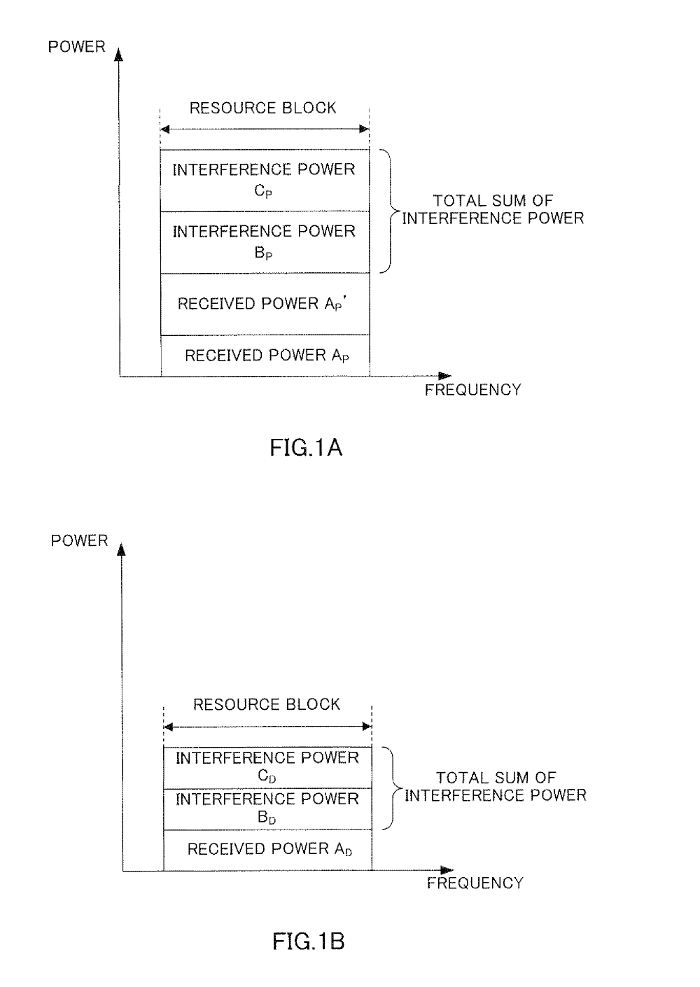

In an uplink pilot channel, a plurality of pilot signals individually transmitted from a plurality of mobile stations are code-multiplexed on the same resource block at the same time. That is, for example, where cells B and C neighbor cell A, FIG. 1A shows the relationship in one resource block in the base station of cell A, between: received power A of a pilot signal transmitted from a mobile station located in cell A; received power A_{P}′ of pilot signals transmitted from a plurality of mobile stations located in cell A; interference power B_{P} from pilot signals transmitted from a plurality of mobile stations located in cell B; and interference power C_{P} from pilot signals transmitted from a plurality of mobile stations located in cell C. That is, the total sum of interference power against received power A_{P}′ is the total of interference power B_{P} and interference power C_{P}.

On the other hand, in an uplink data channel where persistent scheduling is performed, it is possible to assign only a data channel for one mobile station per cell at the same time to the same resource block. That is, FIG. 1B shows the relationship in one resource block in the base station of cell A, between: received power A_{D} of data transmitted from a mobile station located in cell A; interference power B_{D} from data transmitted from a mobile station located in cell B; and interference power C_{D} from data transmitted from a mobile station located in cell C. That is, the total sum of interference power against received power A_{D} is the total of interference power B_{D} and interference power C_{D}.

In this way, the difference between the number of pilot signals multiplexed and the number of pieces of data multiplexed causes that the total sum of interference power (B_{P}+C_{P}) in the pilot channel is greater than the total sum of interference power (B_{D}+C_{D}) in the data channel.

Here, an MCS determined upon persistent scheduling (hereinafter the “first MCS”) is determined for each mobile station based on the SINR of the pilot signal. Further, the total sum of interference power for the pilot channel as explained above is greater than the total sum of interference power for the data channel, the SINR of the pilot signal is smaller than the SINR of data. That is, the MCS level of the first MCS is lower than the MCS level of the optimal MCS that can be originally used as the MCS for the data channel (hereinafter the “second MCS”). In other words, the MCS level for the data channel can be made higher than the MCS level of the first MCS.

On the other hand, when the amount of data is within the amount of data that can be transmitted using the first MCS, it is preferable to use the first MCS having better error characteristics than the second MCS, that is, the first MCS that is more robust than the second MCS.

Then, with the present invention, the mobile station that transmits transmission data using transmission resources assigned in a given period by persistent scheduling in the base station selects the first MCS or the second MCS having a higher MCS level than the MCS level of the first MCS, according to the amount of transmission data varying in the given period.

Now, embodiments of the present invention will be described in detail with reference to the accompanying drawings.

### Embodiment 1

With the present embodiment, the mobile station determines the second MCS from the first MCS.

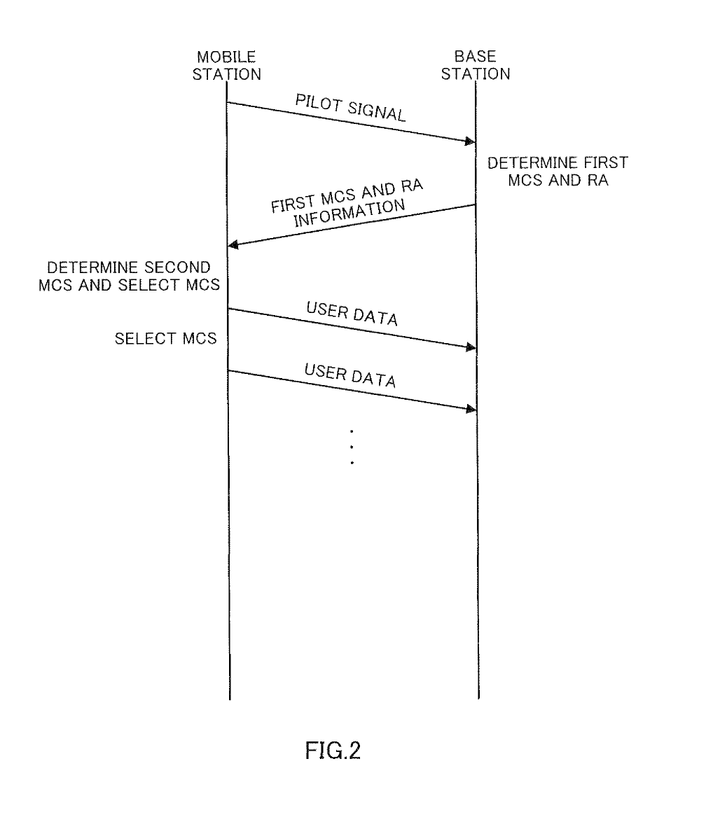

Now, the sequence of operations between the mobile station and the base station according to the present embodiment will be explained. FIG. 2 shows the sequence diagram of operations.

As shown in FIG. 2, each mobile station transmits the pilot signal to the base station in an uplink pilot channel.

The base station performs persistent scheduling using the pilot signal received from each mobile station.

First, the base station finds SINR₁ of the pilot signal as the received quality of the pilot signal per mobile station by equation 1. In equation 1, “S” represents the received power of the pilot signal from each mobile station, “I” represents the total sum of interference power for the pilot signal, and “N” represents noise power.

$$\begin{matrix}[ 1 ] & \\ {SINR}_{1} = \frac{S}{I + N} & ( Equation 1 )\end{matrix}$$

Next, the base station determines the first MCS of a given period of a plurality of subframes on a per mobile station basis according to the SINR₁ per mobile station. Further, the base station determines RA of the given period of a plurality of subframes on a per mobile station basis using the SINR₁.

Then, the base station reports the first MCS and RA information to each mobile station in a downlink control channel.

Each mobile station determines the second MCS from the first MCS received from the base station. By this means, each mobile station memorizes both the first MCS determined upon persistent scheduling in the base station and the second MCS determined in each mobile station from the first MCS after persistent scheduling.

Then, each mobile station selects the first MCS or the second MCS according to the amount of user data to be transmitted, encodes and modulates the user data, and transmits the user data after the coding and modulation to the base station in an uplink data channel.

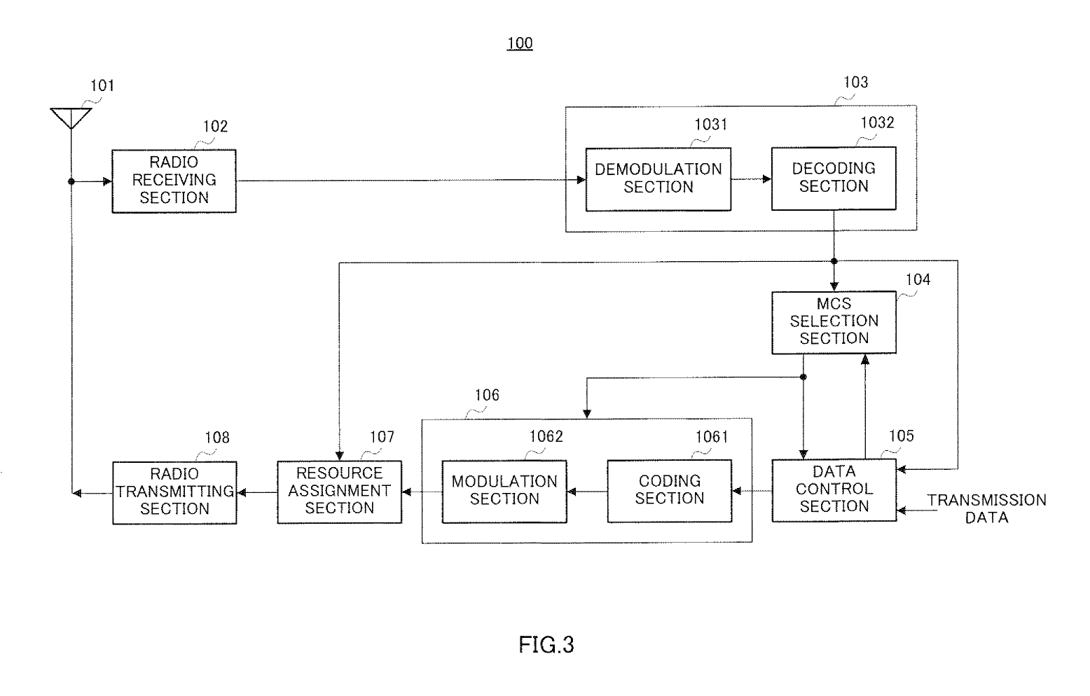

Next, FIG. 3 shows the configuration of mobile station 100 according to the present embodiment.

In mobile station 100, radio receiving section 102 performs radio receiving processing including down-conversion or A/D conversion for a control signal received as input from the base station via antenna 101, and outputs the control signal after radio receiving processing to demodulation and decoding section 103. The control signal includes the first MCS and RA information from the base station.

In demodulation and decoding section 103, demodulation section 1031 modulates the control signal, decoding section 1032 decodes the control signal after demodulation and outputs the decoded control signal to MCS selection section 104, data control section 105 and resource assignment section 107.

MCS selection section 104 selects the second MCS from the first MCS included in the control signal. Further, MCS selection section 104 selects the first MCS or the second MCS as the MCS for transmission data according to the amount of transmission data received as input from data control section 105, and outputs the selected MCS to data control section 105 and coding and modulation section 106. The determination of the second MCS and the selection of MCS will be explained later in detail.

Data control section 105 having a data buffer stores transmission data in the data buffer once, and outputs the amount of transmission data stored in the data buffer to MCS selection section 104. Further, data control section 105 determines a data size that can be transmitted according to the resource block size in the RA information included in the MCS and control signal received as input from MCS selection section 104. When the first MCS is received as input from MCS selection section 104, data control section 105 determines data size 1 according to the first MCS and the resource block size, and, when the second MCS is received as input from MCS selection section 104, data control section 105 determines data size 2 according to the second MCS and the resource block size. The amount of data that can be transmitted in the same resource block size increases when the MCS level is higher. In addition, the MCS level of the second MCS is higher than the MCS level of the first MCS here, and therefore data size 2 is greater than data size 1. That is, data control section 105 increases the data size of transmission data when the MCS level is made higher in the same resource block size. Then, data control section 105 takes out the transmission data of the determined data size from the buffer and outputs the transmission data to coding and modulation section 106.

Coding and modulation section 106 is composed of coding section 1061 and modulation section 1062. Coding section 1061 encodes the transmission data received as input from data control section 105 by the coding rate according to the MCS received as input from MCS selection section 104, and outputs the transmission data after coding to modulation section 1062. Further, modulation section 1062 modulates the transmission data after coding by a modulation scheme according to the MCS received as input from MCS selection section 104, and outputs the transmission data after modulation to resource assignment section 107.

Resource assignment section 107 assigns the transmission data after modulation to the resource block shown by the resource block position in the RA information included in the control signal, and outputs the transmission data after assignment to radio transmitting section 108.

Radio transmitting section 108 performs radio transmitting processing including D/A conversion and up-conversion for the transmission data, and transmits the data to the base station via antenna 101.

Next, the determination of the second MCS and the selection of MCS in MCS selection section 104 will be explained in detail.

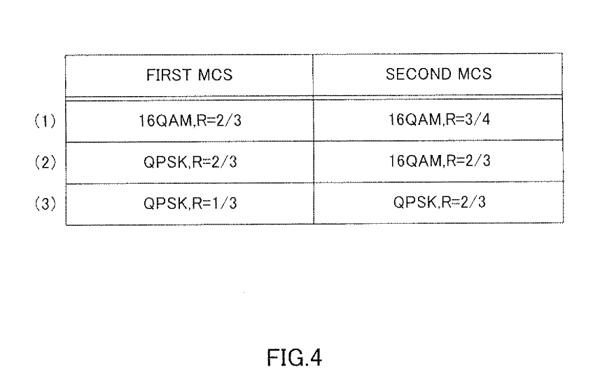

MCS selection section 104 has the MCS table shown in FIG. 4, and determines the second MCS from the first MCS included in the control signal with reference to the MCS table. A plurality of associations, that is, associations between the first MCSs determined by the base station upon persistent scheduling and second MCSs unique to the first MCSs, are set in this MCS table. MCS selection section 104 determines the second MCS from the first MCS included in the control signal with reference to this MCS table. For example, if the first MCS is the modulation scheme: 16QAM and the coding rate: R=⅔ (i.e. in the case of FIGS. 4(1)), MCS selection section 104 determines the modulation scheme: 16QAM and the coding rate: R=¾ as the second MCS. Then, MCS selection section 104 memorizes the first MCS included in the control signal and the second MCS determined from the first MCS.

Here, in the MCS table as shown in FIG. 4, the MCS levels of the second MCSs are set higher than the corresponding MCS levels of the first MCSs. For example, if the first MCS is the modulation scheme: 16QAM and the coding rate: R=⅔ (i.e. in the case of FIGS. 4(1)), the second MCS associated with the first MCS is the modulation scheme: 16QAM and the coding rate: R=¾. Also in the cases of FIGS. 4(2) and (3), the MCS level of the second MCS is higher than the MCS level of the first MCS. In other words, the transmission rate of the second MCS is higher than the transmission rate of first MCS, in cases of the same resource block size, the data size that can be transmitted with the second MCS is greater than the data size that can be transmitted with the first MCS.

Then, MCS selection section 104 selects the first MCS when the amount of transmission data stored in the buffer in data control section 105 is less than a threshold value, and selects the second MCS when the amount of transmission data is equal to or more than the threshold value. Consequently, in mobile station 100, when the amount of transmission data is small for normal operation, data encoded and modulated based on the first MCS is transmitted, and, when the amount of data increases and becomes large, data encoded and modulated based on the second MCS having a higher MCS level than the MCS level of the first MCS is transmitted. By this means, even when the amount of transmission data increases, it is possible to improve throughput momentarily in the same resource block size, that is, without requiring assigning more transmission resources, so that the extra data can be transmitted without delay.

In this way, according to the present embodiment, even when a resource block size is the same in a given period by persistent scheduling in the base station, the mobile station selects a second MCS having a higher MCS level than the MCS level of a first MCS when the amount of transmission data is equal to or more than a threshold value in the given period. Accordingly, according to the present embodiment, even when the amount of transmission data increases momentarily, the mobile station can improve throughput according to an increase in the amount of transmission data without requesting resources. Consequently, according to the present embodiment, in a radio communication system where persistent scheduling is performed, it is possible to prevent transmission delay when the amount of transmission data increases.

Further, according to the present embodiment, the mobile station determines the second MCS from the first MCS, so that the base station does not need to newly report the second MCS to the mobile station, thereby preventing transmission delay when the amount of transmission data increases without increasing the amount of control H signals.

The base station may also determine the second MCS from the first MCS as explained above, and report the second MCS to the mobile station. In this case, the base station may report the second MCS at the same time as the first MCS shown in FIG. 2. That is, the base station may include the first MCS and the second MCS into one control signal and transmit the control signal. This makes it possible to report both the first MCS and the second MCS without increasing the number of times a control signal is transmitted.

Further, the base station may report the second MCS without reporting the first MCS, and the mobile station may determine the first MCS from the second MCS.

### Embodiment 2

The present embodiment is different from Embodiment 1 in reporting the second MCS from the base station to the mobile station. That is, the present embodiment is different from Embodiment 1 in that the base station determines the second MCS. Now, the difference from Embodiment 1 will be explained focusing upon the determination of the second MCS according to the present embodiment.

### Determination Example 1

With the present determination example, the second MCS is determined based on the received quality of a pilot channel and the number of pilots multiplexed in a pilot channel.

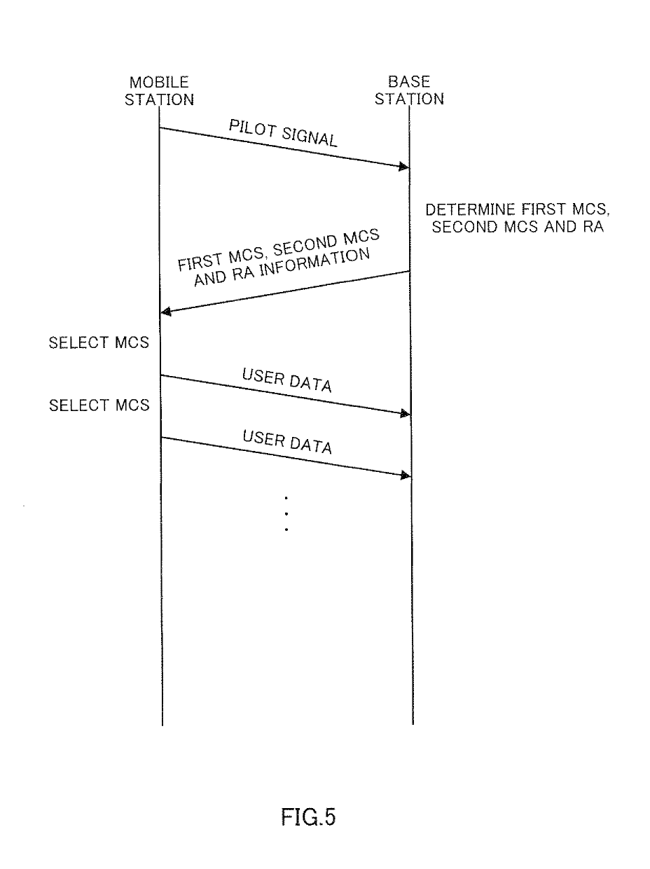

Now, the sequence of operations between the mobile station and the base station according to the present determination example will be explained. FIG. 5 shows the sequence diagram of operations. The base station finds SINR₂ by equation 2. In equation 2, “S,” “I” and “N” are the same as in Embodiment 1, “Numᵤₛₑᵣ” represents the number of users multiplexed in the pilot channel (the number of mobile stations multiplexed), that is, the number of pilots multiplexed in the pilot channel.

$$\begin{matrix}[ 2 ] & \\ {SINR}_{2} = \frac{S}{I / {Num}_{user} + N} & ( Equation 2 )\end{matrix}$$

Next, the base station determines the second MCS on a per mobile station basis according to the SINR₂ per mobile station. Here, comparing equation 1 and equation 2, equation 2 is added “Numᵤₛₑᵣ” to equation 1 representing the received quality of the pilot channel. That is, the base station determines the second MCS based on the received quality of the pilot channel and the number of pilots multiplexed in the pilot channel. Further, in equation 2, by dividing “I” by “Numᵤₛₑᵣ,” interference power is distributed between users. Numᵤₛₑᵣ>1 in usual mobile communication systems so that SINR₂>SINR₁. That is, the MCS level of the second MCS is made higher than the MCS level of the first MCS.

Then, the base station reports the first MCS, the second MCS and RA information to each mobile station in a downlink control channel.

Each mobile station memorizes the first MCS and the second MCS received from the base station. By this means, each mobile station memorizes both the first MCS and the second MCS as MCSs applying to transmission data.

Then, each mobile station selects the first MCS or the second MCS according to the amount of user data to be transmitted, encodes and modulates the user data, and transmits the user data after the coding and modulation to the base station in an uplink data channel.

Next, the difference from Embodiment 1 about the configuration of the mobile station according to the present determination example will only be explained using FIG. 3.

With the present determination example, a control signal received from the base station includes the first MCS, the second MCS and RA information. Accordingly, radio receiving section 102 receives reports of the first MCS and the second MCS at the same time.

MCS selection section 104 memorizes the first MCS and the second MCS included in the control signal, that is, the first MCS and the second MCS reported at the same time from the base station.

Then, MCS selection section 104 selects the first MCS when the amount of transmission data stored in the buffer in data control section 105 is less than a threshold value, and selects the second MCS when the amount of transmission data is equal to or more than the threshold value. Consequently, in mobile station 100, as in Embodiment 1, when the amount of transmission data is small for normal operation, data encoded and modulated based on the first MCS is transmitted, and, when the amount of data increases and becomes large, data encoded and modulated based on the second MCS having a higher MCS level than the MCS level of the first MCS is transmitted. By this means, as in Embodiment 1, even when the amount of transmission data increases, it is possible to improve throughput momentarily in the same resource block size, that is, without requiring assigning more transmission resources, so that the extra data can be transmitted without delay.

Further, according to the present determination example, the base station includes the first MCS and the second MCS determined upon persistent scheduling in one control signal and reports the MCSs at the same time, so that the base station may report both the first MCS and the second MCS without increasing the number of times a control signal is transmitted.

### Determination Example 2

With the present determination example, the second MCS is determined based on the received quality of a data channel.

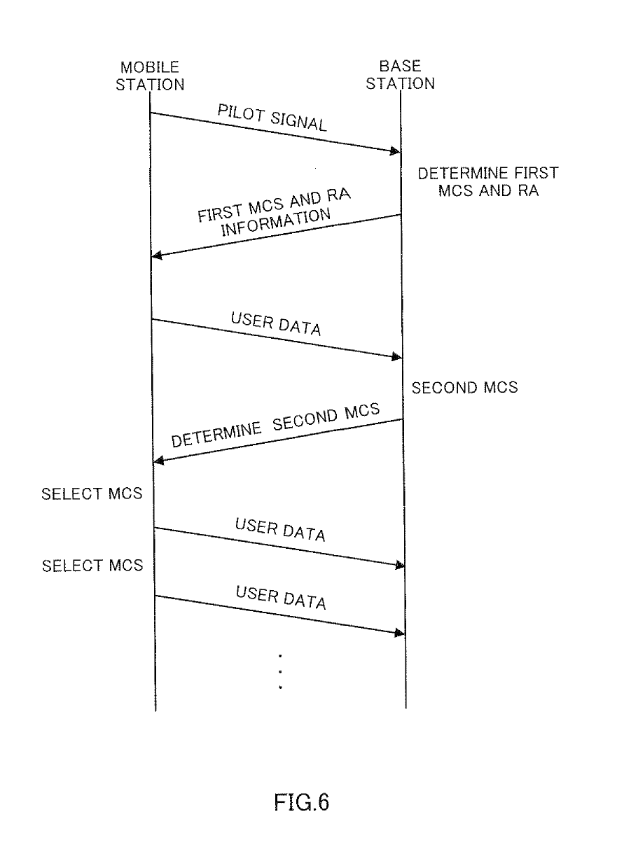

Now, the sequence of operations between the mobile station and the base station according to the present determination example will be explained. FIG. 6 shows the sequence diagram of operations.

Upon a report of the first MCS from the base station, the mobile station encodes and modulates user data according to the first MCS, and transmits the user data after coding and modulation to the base station in an uplink data channel.

The base station receives the user data encoded and modulated according to the first MCS, and determines the second MCS based on the received quality of the user data, that is, the received quality of the data channel.

To be more specific, the base station first finds SINR₂ of a data channel by equation 3, as the received quality of the data channel per mobile station. In equation 3, “S” represents the received power of user data from each mobile station, “R_{Data}” represents the total received power in the data channel, and “N” represents noise power. “R_{Data}−S” in equation 3 is equivalent to “I” in equation 1.

$$\begin{matrix}[ 3 ] & \\ {SINR}_{2} = \frac{S}{{R}_{Data} - S + N} & ( Equation 3 )\end{matrix}$$

Next, the base station determines the second MCS on a per mobile station basis according to the SINR₂ per mobile station. That is, the base station determines the second MCS based on received quality of the data channel. Further, as explained using FIGS. 1A and 1B, SINR₂>SINR₁. That is, the MCS level of the second MCS is made higher than the MCS level of the first MCS.

Then, the base station reports the second MCS to each mobile station in a downlink control channel.

Each mobile station memorizes the second MCS received from the base station. By this means, each mobile station memorizes both the first MCS and the second MCS as MCSs applying to transmission data.

Then, each mobile station selects the first MCS or the second MCS according to the amount of user data to be transmitted, encodes and modulates the user data, and transmits the user data after the coding and modulation to the base station in an uplink data channel.

Next, the difference from Embodiment 1 about the configuration of the mobile station according to the present determination example will only be explained using FIG. 3.

With the present determination example, the control signal for a first time received from the base station includes the first MCS and RA information from the base station. Further, the control signal for a second time received from the base station includes the second MCS from the base station.

MCS selection section 104 memorizes the first MCS included in the control signal for a first time and the second MCS included in the control signal for a second time, that is, the first MCS and the second MCS reported at different timings from the base station.

Then, MCS selection section 104 selects the first MCS when the amount of transmission data stored in the buffer in data control section 105 is less than a threshold value, and selects the second MCS when the amount of transmission data is equal to or more than the threshold value. Consequently, in mobile station 100, as in Embodiment 1, when the amount of transmission data is small for normal operation, data encoded and modulated based on the first MCS is transmitted, and, when the amount of data increases and becomes large, data encoded and modulated based on the second MCS having a higher MCS level than the MCS level of the first MCS is transmitted. By this means, as in Embodiment 1, even when the amount of transmission data increases, it is possible to improve throughput momentarily in the same resource block size, that is, without requiring assigning more transmission resources, so that the extra data can be transmitted without delay.

Further, according to the present determination example, the second MCS is determined based on the received quality of the data channel used to transmit actual data, so that it is possible to make the second MCS to be more accurate MCS.

Further, although with the above explanation, “S” in equation 3 represents the received power of user data from each mobile station, “S” in equation 3 may be derived from adding the amount of user data transmission power offset against pilot signal transmission power, to the received power of the pilot signal for user data modulation, which is transmitted with the user data.

Further, although the second MCS is determined based on received quality of the data channel with the above explanation, the second MCS may be also determined based on the received quality of a pilot signal for modulating user data, which is transmitted with the user data.

Determination examples 1 and 2 have been explained.

In this way, according to the present embodiment, as in Embodiment 1, in a radio communication system where persistent scheduling is performed, it is possible to prevent transmission delay when the amount of transmission data increases.

The second MCS in the present embodiment may be reported by the difference between the first MCS and the second MCS. This makes it possible to reduce the amount of control signals.

### Embodiment 3

As explained above, the first MCS is determined based on received quality of a pilot channel, and therefore the MCS of user data where the sum of interference power is less than a pilot signal, is a MCS having an allowance for error rate characteristics. Further, the second MCS is applied to cases where the amount of transmission data increases, the first MCS is applied to normal operation for which the amount of transmission data is small. By this means, compared to user data transmitted using the second MCS, user data transmitted using the first MCS is demodulated and decoded correctly even if received quality in the base station is more or less deteriorated. In other words, it is possible to make smaller transmission power of user data transmitted using the first MCS than transmission power of user data transmitted using the second MCS by an allowance of the received quality.

Then, with the present embodiment, transmission power control is performed so as to decrease the transmission power of transmission data encoded and modulated according to the first MCS, by the amount of difference between the received quality associated with the first MCS and the received quality associated with the second MCS.

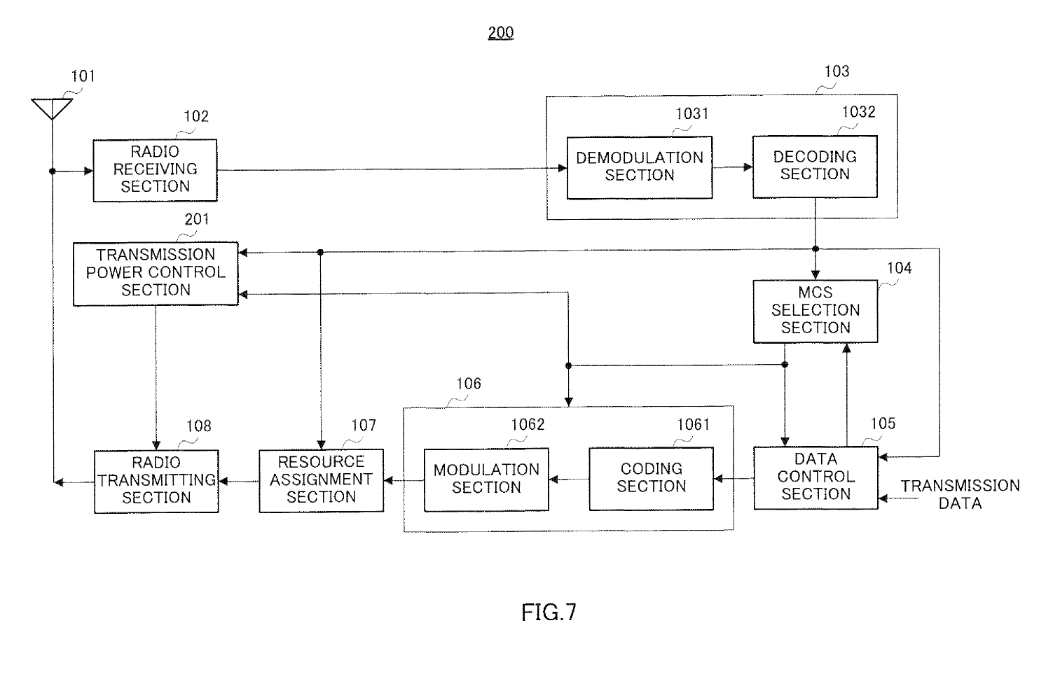

FIG. 7 shows the configuration of mobile station 200 according to the present embodiment. Further, in FIG. 7 the same reference numerals are assigned to the same parts in FIG. 3, and description thereof will be omitted.

In mobile station 200, transmission power control section 201 receives a control signal as input from decoding section 1032. This control signal is the same as the control signal receive as input MCS selection section 104 and data control section 105 in Embodiment 1.

Further, transmission power control section 201 receives the first MCS or the second MCS selected in MCS selection section 104 as input.

When the first MCS is received as input from MCS selection section 104, transmission power control section 201 calculates the amount of transmission power offset based on the first MCS included in the control signal and the second MCS received as input from MCS selection section 104. Then, when the first MCS is received as input from MCS selection section 104, that is, when transmission data is encoded and modulated according to the first MCS, transmission power control section 201 performs transmission power control for radio transmitting section 108 to decrease transmission power of the transmission data by the amount of transmission power offset. By the transmission power control, radio transmitting section 108 decreases the transmission power of the transmission data encoded and modulated according to the first MCS by the amount of transmission power offset.

To be more specific, the amount of transmission power offset ΔP is calculated by equation 4.

Amount of transmission power offset ΔP=SINR associated with the second MCS−SINR associated with the first MCS (Equation 4)

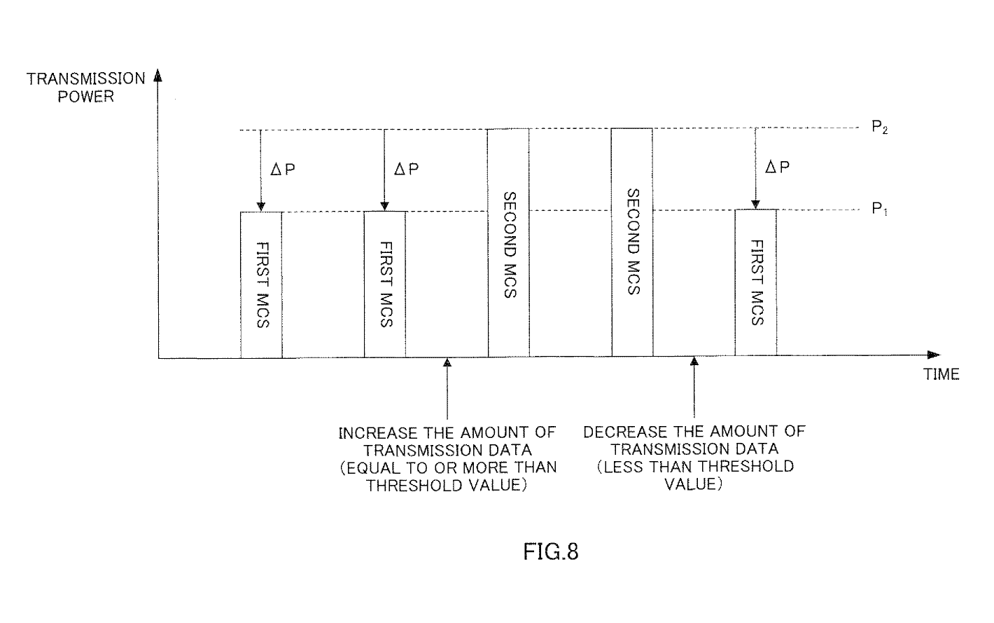

By this transmission power control transmission power of transmission data changes over time as shown in FIG. 8.

That is, when the amount of transmission data is less than a threshold value, that is, when transmission data is encoded and modulated according to the first MCS, the transmission power of the transmission data is controlled to transmission power P₁ decreased from predetermined transmission power P₂ by the amount of transmission power offset ΔP.

Further, when the amount of transmission data is equal to or more than the threshold value, that is, when transmission data is encoded and modulated according to the second MCS, the transmission power of the transmission data is controlled to predetermined transmission power P₂.

Then, when the amount of transmission data decreases again and becomes less than the threshold value, the transmission power of transmission data encoded and modulated according to the first MCS is controlled to transmission power P₁.

In this way, according to the present embodiment, to decrease redundant transmission power of transmission data encoded and modulated according to the first MCS, it is possible to prevent transmission delay when the amount of transmission data increases and reduce interference for other cells.

Although cases have been explained above where the present embodiment is implemented in combination with Embodiment 1, the present embodiment may also be implemented in combination with Embodiment 2. With determination example 2 of Embodiment 2, the second MCS is determined based on the received quality of a data channel. Further, the first MCS is determined based on the received quality of a pilot channel with all the embodiments. That is, the amount of transmission power offset ΔP is represented by equation 5.

Amount of transmission power offset ΔP=Received quality of data channel−received quality of pilot channel (Equation 5)

That is, in the case where the present embodiment is implemented in combination with determination example 2 of Embodiment 2, the transmission power control according to the present embodiment may be said that transmission power control that decreases transmission power of transmission data encoded and modulated according to the first MCS by the difference between the received quality of a data channel and the received quality of a pilot channel.

### Embodiment 4

With the present embodiment, the mobile station transmits transmission data at the same timing as another mobile station in a neighboring cell.

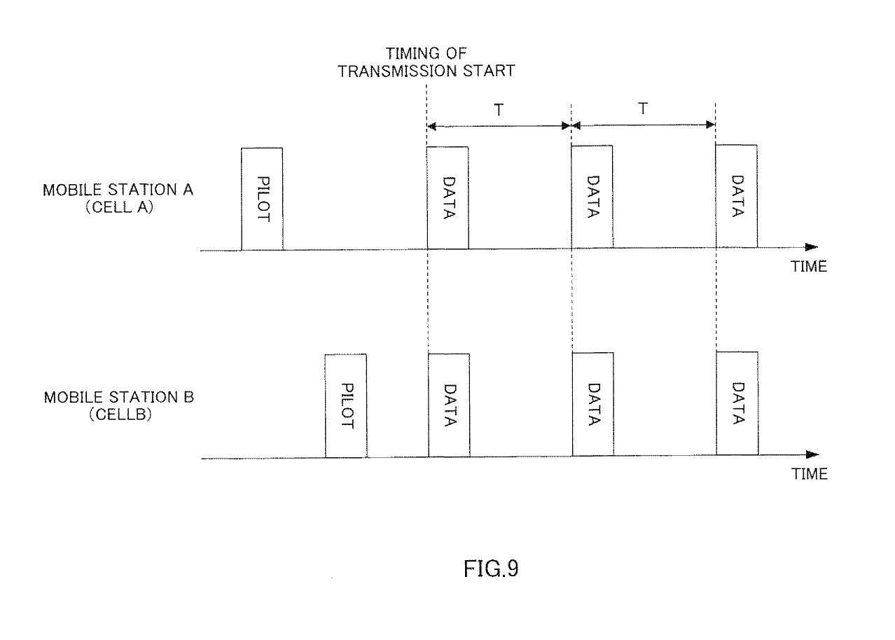

The operations of the mobile stations according to the present embodiment will be explained using FIG. 9. In FIG. 9, as mobile stations for persistent scheduling targets, two mobile stations, that is, mobile station A located in cell A and mobile station B located in cell B neighboring with cell A are assumed. Further, as shown in FIG. 9, a case will be assumed where mobile station A transmits a pilot signal to the base station at earlier timing than mobile station B, and, later than that, mobile station B transmits a pilot signal to the base station.

In this way, mobile station A and mobile station B transmit transmission data at the same transmission timings by matching a starting timing of data transmission and transmission interval T, even when transmission timings of pilot signals are different. That is, mobile station A and mobile station B are coordinated between cells with the present embodiment.

Further, the transmission timings are controlled in radio transmitting section 108 shown in FIG. 3. That is, radio transmitting section 108 transmits transmission data encoded and modulated by coding and modulation section 106 to the base station at the same timing as another mobile station in the neighboring cell.

By the coordination between cells in this way, it is possible to suppress fluctuation of interference power for a data channel between cells. Accordingly, the base station for each cell can measure the received quality of the data channel with good accuracy. Consequently, according to the present embodiment, it is possible to determine more accurately the second MCS (determination example 2 of Embodiment 2) determined based on the received quality of a data channel.

When one cell is divided into a plurality of sectors, the mobile station may transmit transmission data at the same timing as another mobile station in the neighboring sector. That is, a plurality of mobile stations may be coordinated between sectors. In this case, mobile station A in the above explanation is located in is sector A and mobile station B in the above explanation is located in sector B neighboring with sector A. By coordinating a plurality of mobile stations between sectors, as explained above, it is possible to determine more accurately the second MCS determined based on the received quality of a data channel.

Embodiments of the present invention have been explained.

The present invention may be applied to ARQ (Automatic Repeat Request) and, in the above embodiments, may also be configured such that data transmitted for a first time is encoded and modulated according to the first MCS, and data retransmitted is encoded and modulated according to the second MCS.

Further, the mobile station located near the center of a cell has a small interference from other cells. For this reason, near the center of a cell, the difference between the total sum of interference power shown in FIG. 1A and the total sum of interference power shown in FIG. 1B becomes less. That is, the effect obtained in cases where the present invention is implemented near the center of a cell is less than the effect obtained in cases where the present invention is implemented near the cell boundary. Then, the present invention may be implemented only near the cell boundary. In this case, only the mobile stations located near the cell boundary are operated as in the embodiments. Further, the base station reports the second MCS to the mobile stations located near the cell boundary alone.

Although cases have been explained with above embodiments where the first MCS is selected when the amount of transmission data is less than a threshold value and the second MCS is selected when the amount of transmission data is equal to or more than the threshold value, the first MCS may be selected when the amount of transmission data is equal to or less than a threshold value and the second MCS may be selected when the amount of transmission data is more than the threshold value.

Further, although cases have been explained with the embodiments where the received SINR is used as received quality, the received SNR, received SIR, received CINR, received CNR, received CIR, received power, interference power, bit error rate, throughput may also be used as received quality. In addition, received quality information may be referred to as “CQI” (Channel Quality Indicator) or “CSI” (Channel State Information), for example.

Further, the mobile station may be referred to as “UE,” and the base station apparatus may be referred to as “Node-B.”

Further, a “resource block” may also be referred to as a “subband,” a “subchannel,” a “subcarrier block,” or a “chunk.”

Also, although cases have been described with the above embodiments as examples where the present invention is configured by hardware, the present invention can also be realized by software.

Each function block employed in the description of each of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSIs, and implementation using dedicated circuitry or general purpose processors is also possible. After LSI manufacture, utlization of a programmable FPGA (Field Programmable Gate Array) or a reconfigurable processor where connections and settings of circuit cells within an LSI can be reconfigured is also possible.

Further, if integrated circuit technology comes out to replace LSIs as a result of the advancement of semiconductor technology or a derivative other technology, it is naturally also possible to carry out function block integration using this technology. Application of biotechnology is also possible.

The disclosure of Japanese Patent Application No. 2006-305354, filed on Nov. 10, 2006, including the specification, drawings and abstract, is incorporated herein by reference in its entirety.

### INDUSTRIAL APPLICABILITY

The present invention is applicable to, for example, mobile communication systems.

1. A radio communication mobile station apparatus for transmitting transmission data using a transmission resource assigned in a given period by persistent scheduling, the apparatus comprising:
a selection section that selects one of a first modulation and coding scheme and a second modulation and coding scheme, the second modulation and coding scheme having a higher modulation and coding scheme level than the modulation and coding scheme level of the first modulation and coding scheme, according to an amount of transmission data varying in the given period; and
a coding and modulation section that encodes and modulates transmission data according to the selected modulation and coding scheme.

2. The radio communication mobile station apparatus according to claim 1, wherein the selection section selects one of the first modulation and coding scheme determined upon the persistent scheduling and the second modulation and coding scheme determined after the persistent scheduling.

3. The radio communication mobile station apparatus according to claim 1, wherein the selection section selects one of the first modulation and coding scheme determined based on received quality of a pilot channel and the second modulation and coding scheme determined from the first modulation and coding scheme.

4. The radio communication mobile station apparatus according to claim 1, wherein the selection section selects one of the first modulation and coding scheme determined based on received quality of a pilot channel and the second modulation and coding scheme determined based on the received quality and the number of pilots multiplexed in the pilot channel.

5. The radio communication mobile station apparatus according to claim 1, wherein the selection section selects one of the first modulation and coding scheme determined based on received quality of a pilot channel and the second modulation and coding scheme determined based on the received quality of a data channel.

6. The radio communication mobile station apparatus according to claim 1, further comprising a transmission power control section that decreases transmission power of transmission data encoded and modulated according to the first modulation and coding scheme, by a difference between received quality associated with the second modulation and coding scheme and the received quality associated with the first modulation and coding scheme.

7. The radio communication mobile station apparatus according to claim 1, further comprising a transmission power control section that decreases transmission power of transmission data encoded and modulated according to the first modulation and coding scheme determined based on received quality of a pilot channel, by a difference between the received quality of a data channel and the received quality of the pilot channel.

8. The radio communication mobile station apparatus according to claim 1, further comprising a reception section that receives a report of the first modulation and coding scheme and a report of the second modulation and coding scheme at a same time,
wherein the selection section selects one of the reported first modulation and coding scheme and the reported second modulation and coding scheme.

9. The radio communication mobile station apparatus according to claim 1, further comprising a transmission section that transmits the transmission data encoded and modulated by the coding and modulation section at a same transmission timing as another radio communication mobile station apparatus in a neighboring cell or sector.

10. A modulation and coding scheme selection method for transmission data in which a transmission resource is assigned in a given period by persistent scheduling, the method comprising:
selecting one of a first modulation and coding scheme and a second modulation and coding schemer the second H modulation and coding scheme having a higher modulation and coding scheme level than the modulation and coding scheme level of the first modulation and coding scheme, according to an amount of transmission data varying in the given period.
